(19) United States
(12) Patent Application Publication
(10) Pub. No.: US 2012/0327119 A1
(43) Pub. Date: Dec. 27, 2012

(54) USER ADAPTIVE AUGMENTED REALITY MOBILE COMMUNICATION DEVICE, SERVER AND METHOD THEREOF

(75) Inventors: Woontack Woo, Buk-gu (KR); Se Jin Oh, Buk-gu (KR)

(73) Assignee: GWANGJU INSTITUTE OF SCIENCE AND TECHNOLOGY, Buk-gu (KR)

(21) Appl. No.: 13/529,521

(22) Filed: Jun. 21, 2012

(30) Foreign Application Priority Data
Jun. 22, 2011 (KR) 10-2011-0060691

(51) Int. Cl. G09G 5/00

(52) U.S. Cl. 345/633

(57) ABSTRACT

The present disclosure provides an augmented reality mobile communication device and a method and system thereof, which can provide digital content items to individual users by reflecting a user preference associated with user circumstances in the provision of augmented reality. The augmented reality mobile communication device includes: a context inference unit that receives sensory information and predicts a user context regarding a user of a mobile communication device based on the sensory information; a transmission unit that transmits user context data to a server; a receiving unit that receives a personalized content item from the server, the personalized content item being generated based on user profile data and user preference data corresponding to user context data; and an augmented reality content renderer that overlays the received personalized content item on an image captured by a camera.

### CROSS-REFERENCE TO RELATED APPLICATION

This application claims the benefit under 35 U.S.A. §119 of Korean Patent Application No. 10-2011-0060691, filed on Jun. 22, 2011 in the Korean Intellectual Property Office, the entirety of which is incorporated herein by reference.

### BACKGROUND

1. Technical Field

The present disclosure relates to a user adaptive augmented reality mobile communication device, a server and a method thereof, and more particularly, to an augmented reality mobile communication device and server based on user profiling and content item filtering through context-awareness, and a method and system thereof.

2. Description of the Related Art

Augmented reality means overlaying computer-generated content over real environment and is a term derived from virtual environment and virtual reality. Data about the real world can include redundant data or can be insufficient for a user. However, a computer-produced virtual environment makes it possible to simplify or make undesired data invisible. In this way, an augmented reality system combines a real world with a virtual world to allow interaction between a user and the virtual world in real time.

With the development and rapid distribution of mobile communication devices, various types of mobile services have been developed. In addition, it has been actively studied to develop mobile augmented reality systems which allow a user to experience a digital content item in physical space through a mobile device. Most mobile augmented reality systems are focused on realistic augmentation of digital content item associated with a physical object. However, these systems provide a standardized content item without consideration of user context, so that redundant data are often provided to a user.

To overcome for this problem, studies have been made to provide augmented content suited to a user context through combination of a mobile context-awareness technique with augmented reality technology. For this purpose, the mobile augmented reality system is configured to allow user circumstance data such as user locations or the like to be is provided to a user by selecting and augmenting the data in a physical space. However, despite a possibility of different individual preferences as to a content item even under the same circumstance, current augmented reality systems provide the content item without reflecting the individual preferences due to insufficient consideration of a user preference associated with the corresponding circumstance.

### BRIEF SUMMARY

Embodiments of the present disclosure are conceived to solve such problems and provide an augmented reality mobile communication device and a method and system thereof, which can provide digital content items to individual users by reflecting user preferences associated with user circumstances in the provision of augmented reality.

One embodiment of the present disclosure provides an augmented reality mobile communication device including: a context inference unit that receives sensory information and predicts a user context regarding a user of a mobile communication device based on the sensory information; a transmission unit that transmits user context data to a server; a receiving unit that receives a personalized content item from the server, the personalized content item being generated based on user profile data and user preference data corresponding to the user context data; and an augmented reality content renderer that overlays the received personalized content item on an image photographed by a camera.

Another embodiment of the present disclosure provides a method of realizing augmented reality in an augmented reality mobile communication device including: inferring a user context regarding a user of the mobile communication device based on received sensory information; transmitting user context data to a server; receiving a personalized content item from the server, the personalized content item being generated based on user profile data and user preference data corresponding to the user context data; and overlaying the received personalized content item on an image photographed by a camera to provide augmented content.

A further embodiment of the present disclosure provides an augmented reality server including: a receiving unit that receives user context data from a mobile communication device of a user, the user context data being inferred based on sensory information; a user profile manager that generates user profile data corresponding to the user context data; a personalized content generator that predicts and filters a user preference according to the user context based on the user context data and the user profile data to generate a personalized content item; and a transmission unit that transmits the personalized content item to the mobile communication device.

Yet another embodiment of the present disclosure provides a method of realizing augmented reality in an augmented reality server including: receiving user context data from a mobile communication device of a user, the user context data being inferred based on sensory information; generating user profile data according to the user context data; generating a personalized content item by predicting a user preference according to the user context data and the user profile data; and transmitting the personalized content item to the mobile communication device.

According to the embodiments of the present disclosure, personalized content items of augmented reality may be provided to individual users by reflecting a user preference associated with user circumstances or contexts.

### BRIEF DESCRIPTION OF THE DRAWINGS

The above and other aspects, features, and advantages of the present disclosure will become apparent from the detailed description of the following embodiments in conjunction with the accompanying drawings, in which:

FIG. 1 is a block diagram of an augmented reality system in accordance with one embodiment of the present disclosure;

FIG. 2 is a detailed block diagram of the augmented reality system of FIG. 1;

FIG. 3 shows examples of codes for description of context data sensed by sensors;

FIG. 4 is a block diagram of a process of describing a user context according to 5W1H through description and integration of the user context according to 4W1H using sensory information, visual data about an object, or user feedback data;

FIG. 5 shows one example of the process of FIG. 4;

FIG. 6 shows one example of codes for inferring a user intention based on a user location, a visual object, a time, and the like;

FIG. 7 is a block diagram of one embodiment of a user profile manager in accordance with the present invention;

FIG. 8 is a block diagram illustrating augmentation of a content item according to a user context and preference;

FIG. 9 shows one example of an algorithm for inferring a user preference as to a content item according to a user context;

FIG. 10 shows one example of codes for adjusting a feedback value in the user profile manager;

FIG. 11 is a flow diagram of a process of predicting a content item preference of a user based on a user profile in a preference inference unit of a personalized content generator; and

FIG. 12 shows one example of augmented reality actually realized by an augmented reality system according to one embodiment of the present disclosure.

### DETAILED DESCRIPTION

The following description will exemplify the principle of the present invention. Therefore, although not described and illustrated clearly in this specification, the principle of the present invention may be embodied and various apparatuses included in the concept and scope of the present invention may be invented by those skilled in the art. Conditional terms and embodiments enumerated in this specification are clearly intended only to make the concept of the present invention understood. Furthermore, it should be understood that the present invention is not limited to the enumerated embodiments and states.

Furthermore, it should be understood that all detailed descriptions in which specific embodiments as well as the principle, viewpoint, and embodiments of the present invention are enumerated are intended to include structural and functional equivalents. Furthermore, it should be understood that such equivalents include all elements which are developed to perform the same function as equivalents to be invented in the future as well as currently-known equivalents, that is, regardless of the structure.

Therefore, it should be understood that block diagrams of this specification illustrate the conceptual viewpoint of exemplary circuits for embodying the principle of the present invention. Similarly, it should be understood that flowcharts, state transition diagrams, pseudo code and so on can be embodied as computer readable code on a computer readable recording medium, and illustrate various processes which are performed by a computer or processor regardless of whether the computer or processor is clearly illustrated or not.

The functions of various elements illustrated in diagrams including processors or functional blocks indicated by a similar concept to the processors may be provided by the use of hardware having an ability of executing suitable software as well as dedicated hardware. When provided by processors, the functions may be provided by a single dedicated processor, a single common processor, or a plurality of individual processors. Some of the plurality of individual processors may be shared.

The use of processors, controllers, or terms presented as a similar concept to the processors or controllers should not be analyzed by exclusively citing hardware having an ability of executing software. It should be understood that digital signal processor (DSP) hardware, ROM, RAM, and non-volatile memory for storing software are suggestively included without a limitation. Other well-known hardware may be included.

In the claims of this specification, it is intended that a component described as a means for performing a function described in the detailed descriptions include combinations of circuit elements performing the function or methods of performing a function including all forms of software containing firmware and code. The component is coupled to a proper circuit for executing the software to perform the function. In the present invention defined by such claims, functions provided by means enumerated in various manners are combined, and the component is combined with the claim drafting rules. Therefore, it should be understood that any means capable of providing the function is equivalent to that grasped from this specification.

The aforementioned objects, features, and advantages will become more apparent from the following detailed description in connection with the accompanying drawings. Accordingly, the technical spirit of the present disclosure can be easily embodied by those skilled in the art to which the present invention pertains. Furthermore, when it is determined that a specific description of a well-known technology related to the present disclosure may unnecessarily make the purport of the present invention ambiguous in the detailed descriptions of the present invention, the specific description will be omitted. Next, exemplary embodiments of the present disclosure will be described in detail with reference to the accompanying drawings.

The present disclosure provides a user adaptive augmented reality system configured to augment digital content items suited to a user context (circumstances) into a form preferred by a user through a mobile communication device. The mobile communication device recognizes a user context based on sensory information thereto and grasps a user intention about the corresponding context based on context history. In addition, the user adaptive augmented reality system continuously accumulates a user profile based on history about a user interaction (such as a content item selection, content item playing time, and the like) through the mobile communication device, and predicts a content item preference of a user according to the corresponding context in real time. As such, the augmented reality system selects a suitable content item corresponding to context and preference and augments the selected content item into a suitable form in a physical space.

The augmented reality system according to the present disclosure integrates and interprets sensory information from various sensors (sensors embedded in the mobile communication device or distributed in a user environment) and infers a user intention in real time with respect to the corresponding context based on a rule defined in a context knowledgebase. That is, the augmented reality system employs data generated by the sensors embedded in the mobile communication device or distributed in the user environment in order to increase accuracy of inference as to the user context. Further, the augmented reality system continuously accumulates user feedback data (a click-based selection, logging data, such as playing time and the like) with respect to the content item provided according to context, and predicts a recent content item preference (keyword of preferred data, description forms) of a user in real time. Here, user feedback may include explicit feedback and implicit feedback, in which the click-based selection pertains to explicit feedback, and the playing time and the like include logging data regarding a user behavior and may pertain to implicit feedback. In addition, the augmented reality system selects a suitable content item corresponding to context and preference, and adaptively determines a description form depending on presence of the associated object. For example, if the associated object is present on a screen of the mobile communication device, the system performs augmentation of the content item, and if there is no associated object thereon, the system allows the content item to be directly displayed on the screen of the mobile communication device. With this configuration, the augmented reality system may improve user satisfaction with respect to the augmented content.

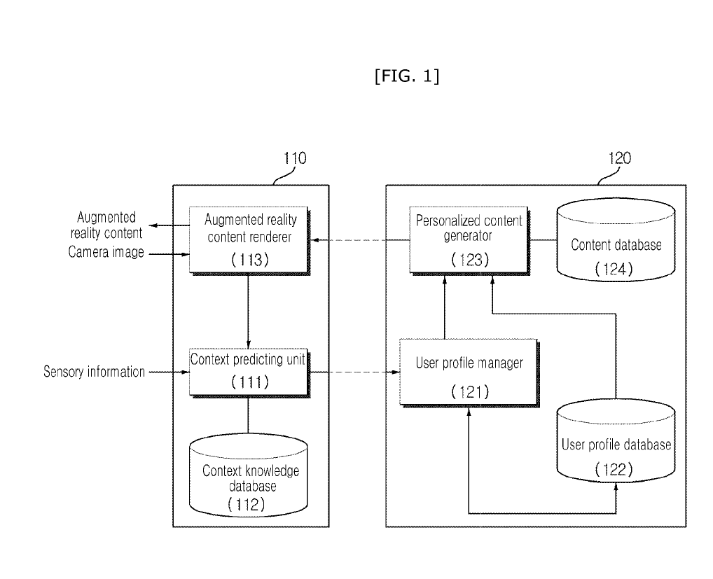

FIG. 1 is a block diagram of an augmented reality system in accordance with one embodiment of the present disclosure.

Referring to FIG. 1, the system according to this embodiment generally includes a mobile communication device 110 and a server 120. The mobile communication device 110 includes a context predicting unit 111 for context awareness and an augmented reality content renderer 113 for augmentation of content. The server 120 includes a user profile manager 121 for context-awareness user profiling and a personalized content generator 123 for customization of a content item.

This system improves accuracy of prediction as to a user context using data generated by sensors embedded in the mobile communication device or distributed in a user environment. Further, this system continuously accumulates user feedback data (a click-based selection, logging data, such as playing time and the like) with respect to a content item provided according to context, and predicts a recent content item preference (keyword of preferred data, description forms) of a user in real time. In addition, the augmented reality system selects a suitable content item corresponding to context and preference, and adaptively determines an description form depending on presence of the associated object (if the associated object is present on a screen of the mobile communication device, the system performs content augmentation, and if there is no associated object thereon, the system allows the content item to be directly displayed on the screen of the mobile communication device).

This system has three features. First, this system improves accuracy as to a content item of a user by integrating and interpreting data generated by various actual sensors. Second, this system enables prediction of a content item preference of a user by continuously accumulating and updating user feedback data as to the content item together with context data. Third, this system enables suitable changes of a description form as to a selected content item according to user circumstances.

The augmented reality-based mobile communication device 110 includes a context predicting unit 111 that receives sensory information and infers a user context regarding a user of the mobile communication device 110 based on the sensory information; a transmission unit (not shown) that transmits user context data to the server; a receiving unit (not shown) that receives a personalized content item from the server, in which the personalized content item is generated based on user profile data and user preference data corresponding to the user context data; and an augmented reality content renderer 113 that overlays the received personalized content item on an image captured by a camera. The sensory information may include information generated from the sensors embedded in the mobile communication device 110 or distributed in the user environment. Further, the sensory information may include user input data to the mobile communication device 110 or image data input through the camera.

The context inference unit 111 may include a context collector that collects the sensory information and classifies the collected sensory information according to a preset standard, and a context inferring unit that infers the user context based on the collected data. The augmented reality content renderer 113 may include an object tracking unit that recognizes and traces an object of an image captured by the camera, and a content rendering unit that renders the personalized content item according to the object. Here, the content rendering unit may render the personalized content item in a data type and a presentation format based on user profile data and user preference data.

A method of realizing augmented reality in the augmented reality mobile communication device includes predicting a user context regarding a user of the mobile communication device based on received sensory information; transmitting user context data to the server; receiving a personalized content item from the server, in which the personalized content item is generated based on user profile data and user preference data corresponding to the user context data; and overlaying the received personalized content item on an image photographed by a camera to provide augmented content.

The augmented reality server 120 includes a receiving unit (not shown) that receives user context data from the mobile communication device of a user, in which the user context data is predicted based on sensory information; a user profile manager 121 that generates user profile data corresponding to the user context data; a personalized content generator 123 that predicts and filters a user preference according to the user context based on the user context data and the user profile data to generate a personalized content item; and a transmission unit (not shown) that transmits the personalized content item to the mobile communication device. Here, the sensory information may include data generated by the sensors embedded in the mobile communication device 110 or distributed in a user environment. Further, the sensory information may include user input data to the mobile communication device 110 or image data input through the camera. The user input data may include explicit input data of a user to the mobile communication device 110 and logging data of a user to the mobile communication device 110.

The user profile manager 121 may include an explicit profile generator for generating an explicit profile of a user based on the explicit input data, an implicit profile generator for generating an implicit profile of the user based on the logging data of the user, and a user profile accumulator for accumulating and updating user profile data based on the explicit profile and the implicit profile.

The personalized content generator 123 may include a content preference inference unit for predicting a content item preference of a user according to user context based on the user context data and the user profile data, and a content filtering unit for evaluating and filtering content items in a content database according to a degree of similarity with respect to the content item preference. Here, the content filtering unit may evaluate and filter the content items based on the data type and the presentation format based on the user profile data and the user preference data.

A method of realizing augmented reality in the augmented reality server includes: receiving user context data from the mobile communication device of a user, in which the user context data is predicted based on the sensory information; generating user profile data according to the user context data; generating a personalized content item by predicting and filtering a user preference according to the user context based on the user context data and the user profile data; and transmitting the personalized content item to the mobile communication device

### Embodiments

Next, exemplary embodiments of the present disclosure will be described with reference to the accompanying drawings.

The augmented reality system is generally constituted by a mobile communication device and a server, and is configured to automatically detect a user context, to predict a user's current preference as to a content item in a given context, and adaptively provides a selected content item to a user.

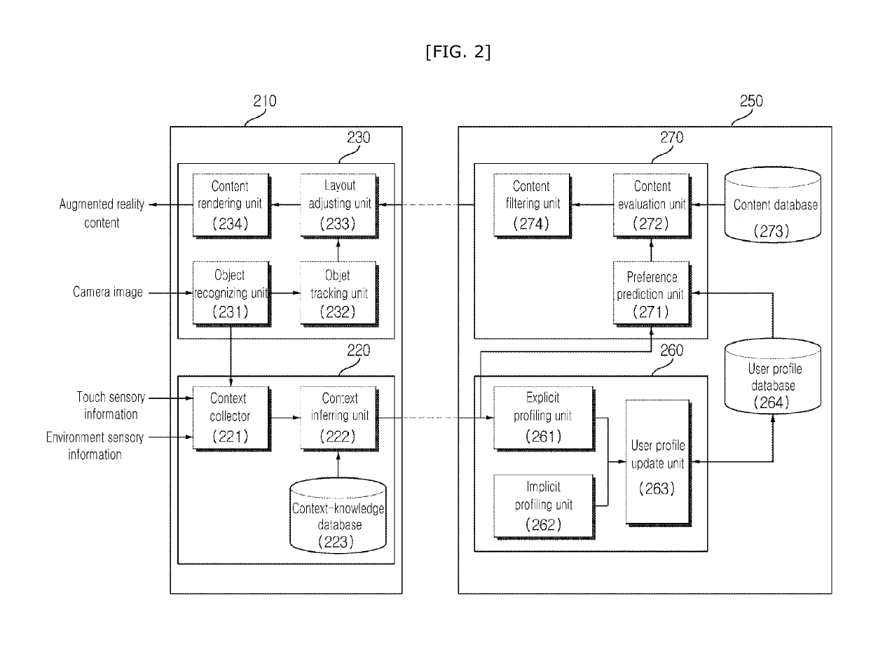

FIG. 2 is a detailed block diagram of the augmented reality system of FIG. 1. Next, the overall operation of the system will be described with reference to FIG. 2.

A context inference unit 220 of a mobile communication device 210 generates description data regarding a user context by collecting and interpreting circumstance data provided by a sensor of the mobile communication device 210 and/or sensors distributed in a user environment based on a context-knowledge (KB) database 223. A user profile manager 260 of a server 250 continuously updates user profile data by performing explicit profiling and implicit profiling based on user feedback data collected from the mobile communication device 210 and the description data regarding the user context. A personalized content generator 250 of the server 250 adaptively predicts a data type and a presentation format preferred by a user from the context provided from the user profile, evaluates content items according to user preference, and determines a suitable presentation form. An augmented reality content renderer 230 of the mobile communication device 210 renders a user a selected content item together with an associated object of an image captured by a camera.

Next, operations of the components of the system will be described in more detail.

1. Context Awareness in Mobile Communication Device

For context awareness, it is necessary to obtain data for allowing context awareness. In this embodiment, variation relating to a user context data is sensed by a sensor, and the context inference unit 220 converts sensory information into description data which indicates the user context. The context inference unit 220 may include a context collector 221 that collects and classifies the sensory information, and a context prediction unit 222 that infers a user context based on the collected data. The context prediction unit 222 may infer the user context with reference to the context knowledge database 223, which stores various types of context data.

The sensors may be placed in the mobile communication device 210 or may be distributed in a surrounding environment of a user, and the sensory information may include touch sensory information from the mobile communication device and environment sensory information from the sensors placed in the mobile communication device or from the sensors distributed in the environment. In this embodiment, 5W1H description (who, what, where, when, why, and how) is illustrated as a method of describing the variation relating to the user context by way of example. Each element may be described by an attribute and a value.

The sensors may include both physical and virtual sensors.

For example, when a user views a book via a camera, the physical sensor senses reading or studying as a current user context. In this case, the context collector 221 may receive data about an object from an object recognizing unit 231 which recognizes an object of the augmented reality content renderer 230. Further, the current user context may be sensed by a movement sensor placed in the mobile communication device 210 or by a sensor for detecting a user's location or light around a user.

As in a content viewer sensing selection recognition, the virtual sensor may sense variation in context of a user, who uses a particular application in the mobile communication device. For example, when a user selects a certain content item while searching a content list using the content viewer, a selection recognition sensor generates context description data, which indicates that the user selects the certain content item through the content viewer.

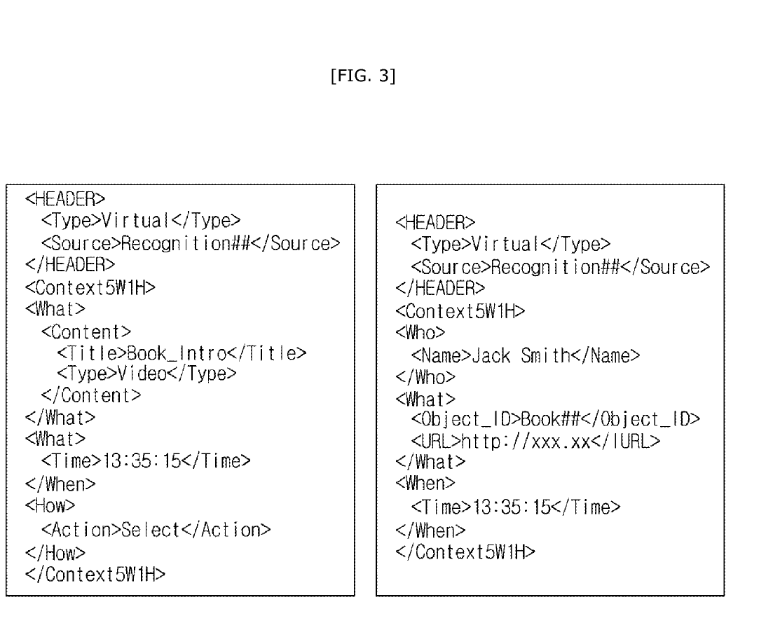

FIG. 3 shows examples of codes for description of contexts sensed by sensors. FIG. 3(a) shows codes for 5W1H description of a particular context sensed by a virtual sensor, and FIG. 3(b) shows codes for 5W1H description of recognition of a book based on an image photographed by a camera as a physical sensor.

The augmented reality system according to this embodiment obtains data about user circumstances from the sensors and automatically recognizes a user context based on analysis of the circumstance data. Data for recognition of the user context may include not only data obtained from the sensors, but also visual data about an object (that is, data about an image from the camera) or user feedback data, and these types of data are classified according to 5W1H description in order to describe the user context. In this embodiment, data is obtained for recognizing the user context in 4W1H description excluding a ‘why’ element among 5W1H, for convenience of illustration. In this case, the data collected for the 4W1H description method may be used to infer the ‘why’ element, which describes a user intention.

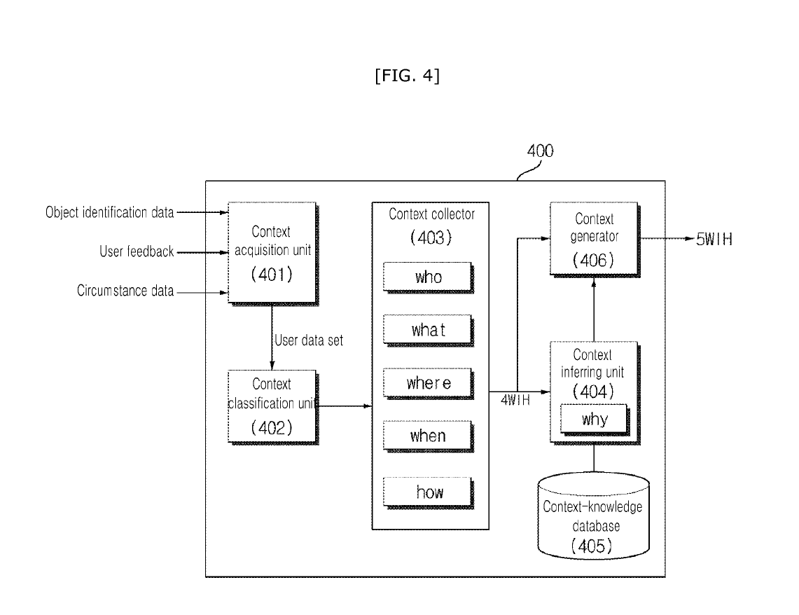

FIG. 4 is a block diagram of a process of describing a user context according to 5W1H through description and integration of the user context according to 4W1H using sensory information, visual data about an object, or user feedback data.

Referring to FIG. 4, a context acquisition unit 401 of the context predicting unit 400 receives object identification data from an object recognizing unit, user feedback data, situation data, and the like. A set of circumstance data acquired by the context acquisition unit 401 is classified by a context classification unit 402 and collected according to 4W1H by the context collector 403. Then, a context inferring unit 404 infers a ‘why’ element based on the collected 4W1H data, and a context generator 406 generates 5W1H data by gathering the collected 4W1H data and the inferred ‘why’ element. At this time, the context inferring unit 404 may refer to a context-knowledge database 405.

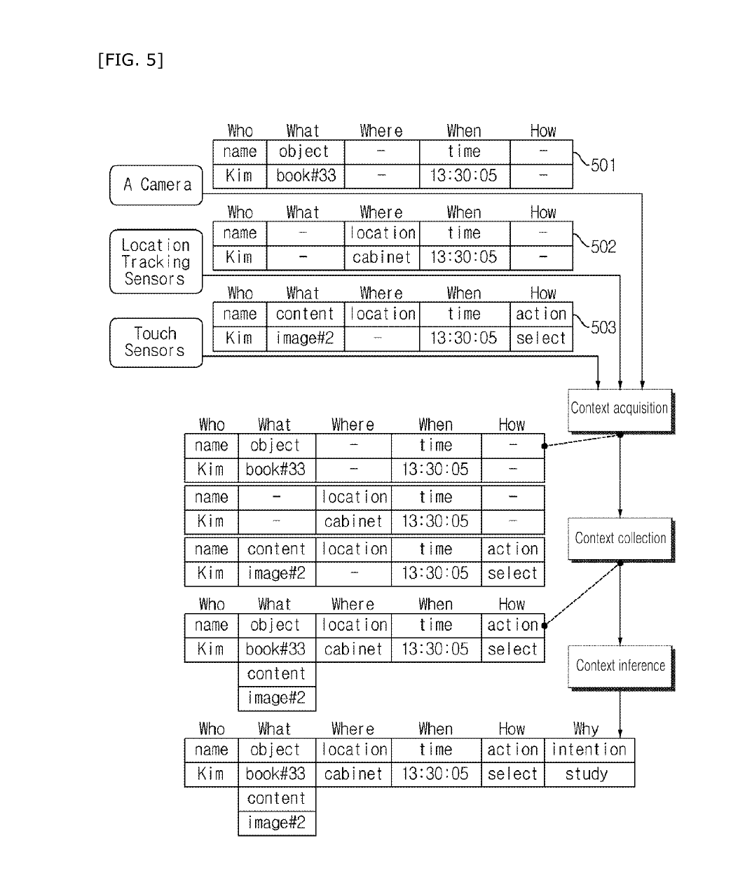

FIG. 5 shows one example of the process of FIG. 4.

Referring to FIG. 5, 4W1H data 501, 502, 503 are gathered from a camera, a location tracking sensor, and a touch sensor in 504, and collected according to 4W1H in 505, and a context is inferred according to the collected 4W1H data in 506, whereby a user intention, that is, ‘study’, is inferred as a ‘why’ element.

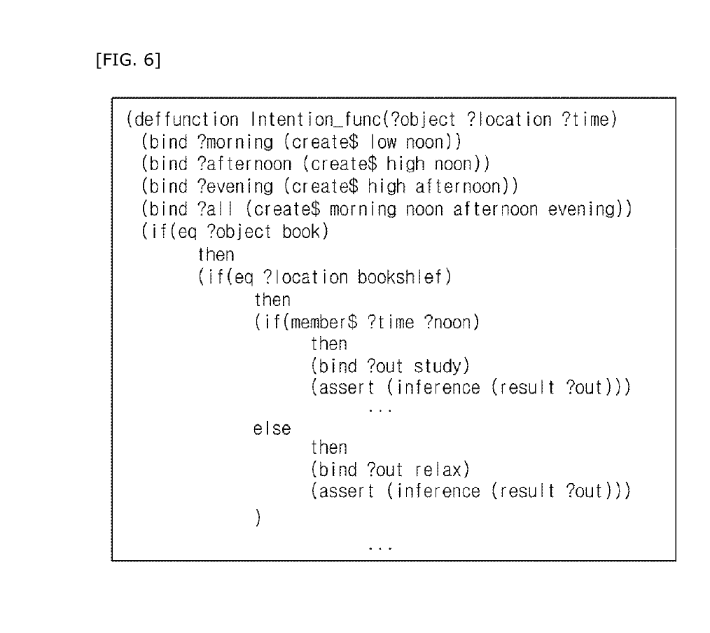

In this embodiment, a set of situation-result rules may be used as a method for inferring a user intention. Each rule may be composed of if-then paragraphs describing a relationship between a contextual factor and a desired intention. FIG. 6 shows one example of code for inferring a user intention based on a user location, a visual object, a time, and the like.

The user intention is added as the ‘why’ element to 4W1H by combining the inferred results with integrated data, so that description data regarding the current context according to 5W1H is generated.

2. Context-Awareness User Profiling

The augmented reality system according to this embodiment continues to accumulate and update user profile data, which describes a user preference to content item, according to a user context in order to understand a user preference for content customization. Context data (in the above example, 5W1H description data) sent from the context inference unit 220 may include user feedback data regarding a content item under a particular circumstance, and the feedback data is input into the user profile manager 260.

The user profile manager 260 may include an explicit profiling unit 261 which performs user profiling according to explicit feedback input from among the feedback data, an implicit profiling unit 262 which performs user profiling according to implicit feedback input from among the feedback data, and a user profile update unit 263 which accumulates and updates the user profile data based on explicit/implicit feedback from the explicit and implicit profiling units 261, 262.

The feedback data may include explicit feedback data such as a click behavior of a user to select a certain item, and implicit feedback data such as logging data regarding a user behavior on the system in order to allow the user behavior on the augmented reality system to be inferred. Such logging data may be used as data for implicitly delivering a user evaluation as to a content item. For example, when a user plays a certain content item for a long time or repeatedly plays the certain item through the mobile communication device 210, it can be evaluated that a user preference as to the corresponding content item is high.

In the augmented reality system according to this embodiment, since different evaluations can be made on a certain content item according to respective contexts of users, a relationship between such feedback data and a contextual factor is evaluated. In other words, the user profile data may include not only the context description data, but also preference feature data and weight data regarding weight values of preference features. The preference feature data may include data about a preference data type and a presentation format, which describe user preference data, such as sound data, text data, and the like.

The user profile manager 260 updates user profile data with respect to an explicit user behavior. Profiling according to such an explicit user behavior is referred to as explicit profiling, in which the user profile manager accumulates and updates the user profile data using feedback data by the explicit user behavior such as touching or clicking an icon displayed on a screen of the mobile communication device. The user profile manager may generate a user profile relating to a user preference as to a certain content item by setting different feedback values for the user behavior according to circumstances such as selection, ignorance, deletion, or automatic selection after a predetermined period of time. A user may request another content item instead of a recommended content item. A content item selected by a user may be interpreted as a content item suited to the user (preferred to by the user). In a context Cox provided with respect to a certain content item Ci, a preference feature value (ΔEF_{CiCOx}) with respect to the content item based on user selection may be adjusted according to the rule of the following Equation 1. Explicit profiling may be performed using a preference value of +2α in the case where a user selects the certain content item Ci; a preference value of +α in the case where the certain content item Ci is automatically selected (due to a lapse of time or the like); a preference value of −α in the case where the certain content item Ci is ignored; and a preference value of −2α in the case where a user deletes the certain content item Ci. Here, α is a scale factor with respect to a feedback value and is greater than zero.

$$Δ {EF}_{{CiCo}_{x}} = \{ \begin{matrix}+ 2 α \\ + α \\ - α \\ 2 α\end{matrix} \qquad < Equation 1 >$$

The user profile manager may update user profile data with respect to an implicit user behavior. Profiling according to such an implicit user behavior is referred to as implicit profiling, in which the user profile manager accumulates and updates the user profile data with respect to the user behavior based on a period of time for playing a certain content item, logging data for playing the corresponding content, or the like, when a user plays the certain content item. Implicit profiling is distinguished from explicit profiling wherein the user profile data is generated by a direct behavior of a user. That is, a behavior of selecting a certain content item pertains to explicit feedback data and generates explicit profiling, whereas logging data as to how long a user plays a selected content item pertains to implicit feedback data and generates implicit profiling. When the content item is played for a long period of time, it can be determined that a user preference with respect to the content item is high. In a context Cox provided with respect to a certain content item Ci, a preference feature value (ΔIF_{CiCOx}) with respect to the content item based on user selection may be adjusted according to the following Equation 2.

$$Δ {IF}_{{CiCO}_{x}} = α \times \frac{{T}_{v}}{{T}_{d}} ∈ [ 0 , α ] \qquad < Equation 2 >$$

Here, Tv is an actual playing time of a user and Td is a total playing time of the content item Ci. When the content item is an image or text, Tv and Td may be set to the same value.

In this way, for a preference factor relating to the selected content item Ci in the context COx given by such explicit feedback and implicit feedback such as logging behavior, the overall feedback at a current time may be evaluated according to Equation 3.

f_{C}_{ᵢ}_{CO}_{ₓ}(t)=(1−σ)×f_{C}_{ᵢ}_{CO}_{ₓ}(t−1)+σ×ΔF_{C}_{ᵢ}_{CO}_{ₓ} <Equation 3>

Then, a new feedback value may be obtained according to Equation 4.

ΔF_{C}_{ᵢ}_{CO}_{ₓ}=wₑ×ΔEF_{C}_{ᵢ}_{CO}_{ₓ}+wᵢ×ΔIF_{C}_{ᵢ}_{CO}_{ₓ}(0≦wₑ≦1, 0≦wᵢ≦1, wₑ+wᵢ=1) <Equation 4>

A high calculation value means that a user considers that a preference value relating to the corresponding content item is suitable for the corresponding context. Here, f_{C}_{ᵢ}_{CO}_{ₓ}(t−1) means a previous feedback value with respect to the content item Ci in the same COx. The f_{CiCOx}(t−1) value is set to zero if there is no previous data. σ is a coefficient relating to an updating rate and determines how fast the previous feedback value is updated to a new feedback value. ΔEF_{CiCOx} is a value obtained from explicit profiling by Equation 1 and ΔIF_{CiCOx} is a value obtained from implicit profiling by Equation 2. Wₑ and Wᵢ are weight factors for relative importance of explicit feedback and implicit feedback.

Then, the user profile data with respect to the past preference factor in the same context is continuously updated based on the evaluated feedback value.

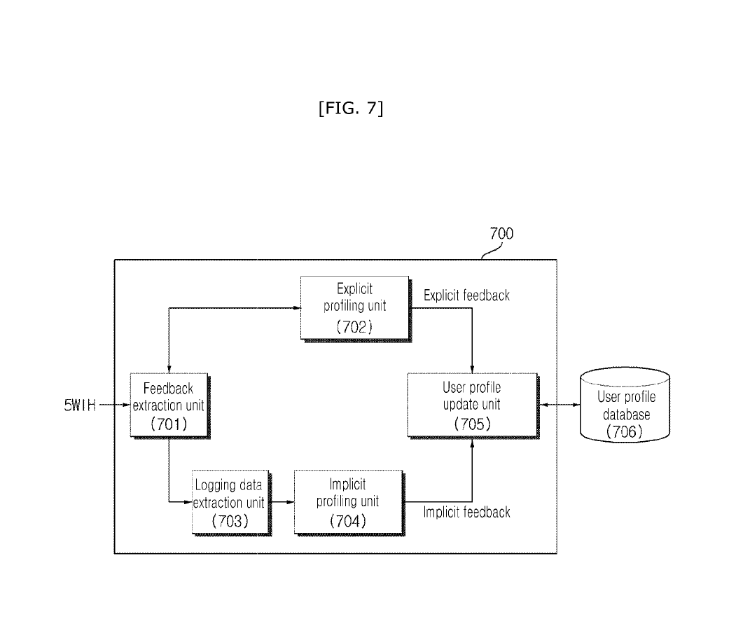

FIG. 7 is a block diagram of one embodiment of the user profile manager in accordance with the present invention.

Referring to FIG. 7, the user profile manager have the same configuration as that of the user profile manager shown in FIG. 2, except that it further includes a feedback extraction unit 701 which extracts a feedback value from 5W1H predicted by the context predicting unit 220, and a logging data extraction unit 703 which extracts logging data of a user in order to perform implicit profiling in the feedback extraction unit 701.

3. Augmentation of Personalized Content Item

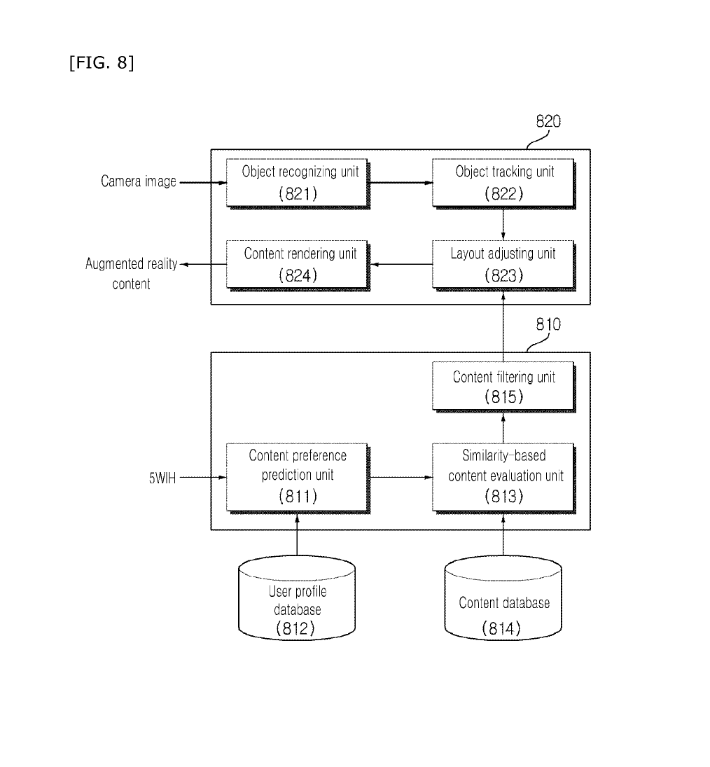

The personalized content generator 270 predicts a content item preference of a user from the current context, and extracts metadata of possible content items in a given context from a content database 273. The augmented reality content renderer 230 overlays a personalized content item on an object in a camera image to provide augmented content. The personalized content generator 270 and the augmented reality content renderer 230 will be described hereinafter with reference to FIG. 8.

FIG. 8 is a block diagram illustrating augmentation of a content item according to user context and preference.

Referring to FIG. 8, the personalized content generator 270 may include a content preference predicting unit 811 which predicts a content item preference of a user based on a user profile database 812 and context description data 5W1H; a similarity-based content evaluation unit 813 which evaluates the content item preference based on the degree of similarity; and a content filtering unit 815 which filters content items according to the evaluation result of the similarity-based content evaluation unit 813 to select a personalized content item. The similarity-based content evaluation unit 813 evaluates content items stored in a content database 814 by comparing the content items with each other.

The augmented reality content renderer 820 may include an object recognizing unit 821 which recognizes an object from a camera image; an object tracking unit 822 which traces the recognized object; a layout adjusting unit 823 which displays the traced object and a personalized content item; and a content rendering unit 824 which renders the content item according to the adjusted layout.

In order to select a content item according to a user preference, the personalized content generator performs content item filtering based on similarity between the preference and an extracted content item. Then, the personalized content generator generates a list of content items having similarity, determines a presentation form according to a spatial relationship between a current context and the content items, and outputs a personalized content item to the mobile communication device according to the determined presentation form. The presentation form may also be determined based on user preference and context.

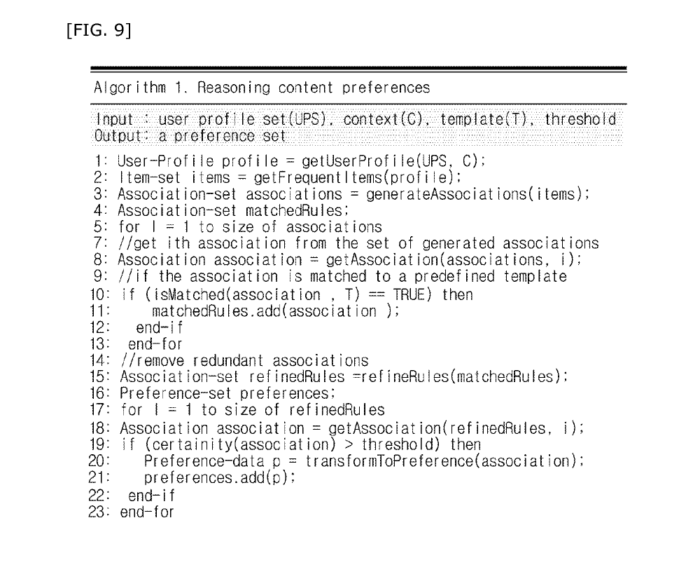

In order to infer the content item preference of a user according to the context, a useful association between different contexts and preference features may be confirmed. As a result, it is possible to remove a redundant association and generate data regarding the content item preference with respect to a set of associations having a higher degree of certainty than a reference value. An exemplary algorithm of this process is illustrated in FIG. 9.

The user preference may be expressed by a vector composed of two elements, that is, a feature and a weight value. This vector is referred to as a preference vector. Each feature may be expressed by combination of a data type and a presentation format, and the weight value may be expressed by an evaluated value as to fondness or dislike with respect to the corresponding feature. When the preference has different features, it may be expressed by a set of vectors thereof. Meanwhile, each of available content items in the current context may also be expressed by a vector composed of a feature of the preference and a weight value corresponding to the feature. This vector may be referred to as a content vector. For the filtered content items, the features do not have the same degree of importance, and thus a relative degree of importance may be allocated to the content items according to fields of the content items. Herein, the field is defined by a set of type and function (S=type, function) to express each feature composed of a data type and a presentation format. An exemplary algorithm for predicting content preference is illustrated in FIG. 9.

After inferring the content preference in a given context, similarity between an available content item in the context and the preference with respect to the content item is evaluated. To this end, similarity between the content vector and the preference vector is determined. Such similarity can be measured using a cosine angle between the preference vector and the content vector, and the measured value is then compared with a preset value.

The content items determined in this way may be sequentially displayed according to the degree of similarity and be changed in display size according to the screen size of the mobile communication device so as not to generate a scroll bar on the screen.

The selected content item may be differently visualized according to a spatial relationship with respect to the user context. For example, when a user approaches a content item by clicking the corresponding item on the screen, a suitable presentation form is determined according to presence of a physical object associated with the corresponding content item. That is, when a user views a certain physical object through the mobile communication device and selects a content item associated with the physical object, the selected content item may be displayed to overlap the corresponding object. On the contrary, when there is no physical object associated with the selected content item, the content item may be displayed over the screen of the mobile communication device. Accordingly, in order to visualize the selected content item, it is important to grasp which physical object is present within a visual field of a camera. This operation can be realized by allowing the camera to photograph the physical object and comparing the photographed physical object with a database with respect to the object. According to this embodiment, it is possible to reduce the number of objects to be compared in the database using the user context such as a current location in order to reduce a process time in such a method. Since data about the visual field of the camera may be important in determination of the user context, this data may be sent to the context predicting unit 220.

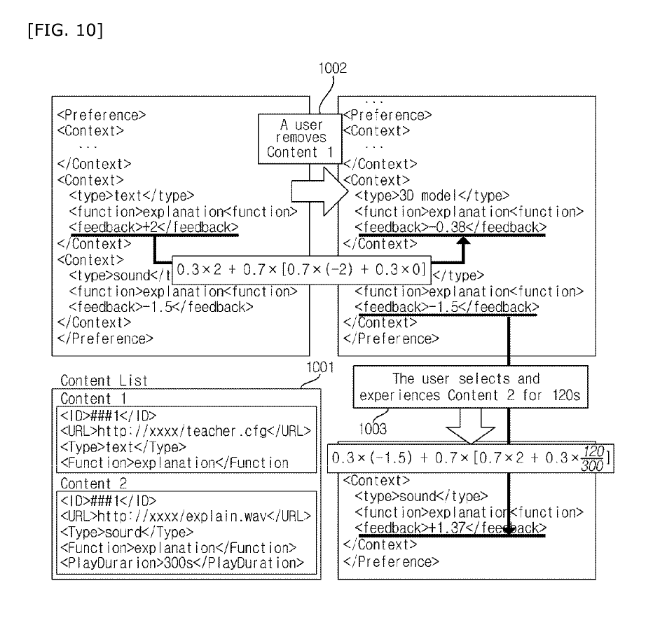

FIG. 10 shows one example of codes for adjusting a feedback value in the user profile manager 260, in which α is 1, Wₑ is 0.7, and Wᵢ is 0.3. In this example, a user removes content item 1 from a content list 1001 in 1002 and plays a content item 2 for 120 seconds in 1003.

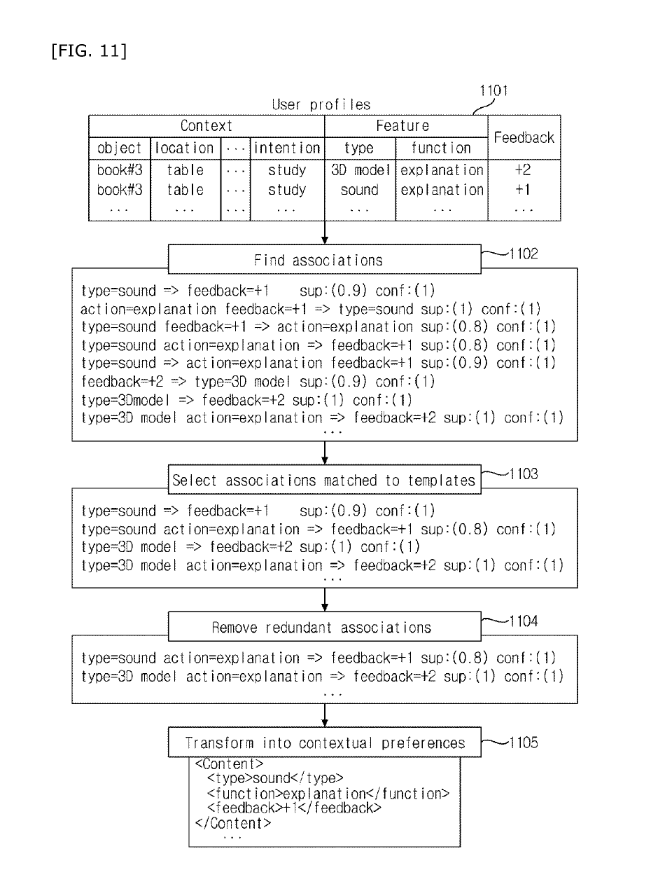

FIG. 11 is a flow diagram of a process of predicting a content item preference of a user based on a user profile in a preference prediction unit 271 of the personalized content generator 270. Referring to FIG. 11, first, useful associations are searched from the user profiles 1011 in 1102, template-matching associations are selected in 1103, and a redundant association is removed in 1104, followed by changing to a contextual preference in 1105.

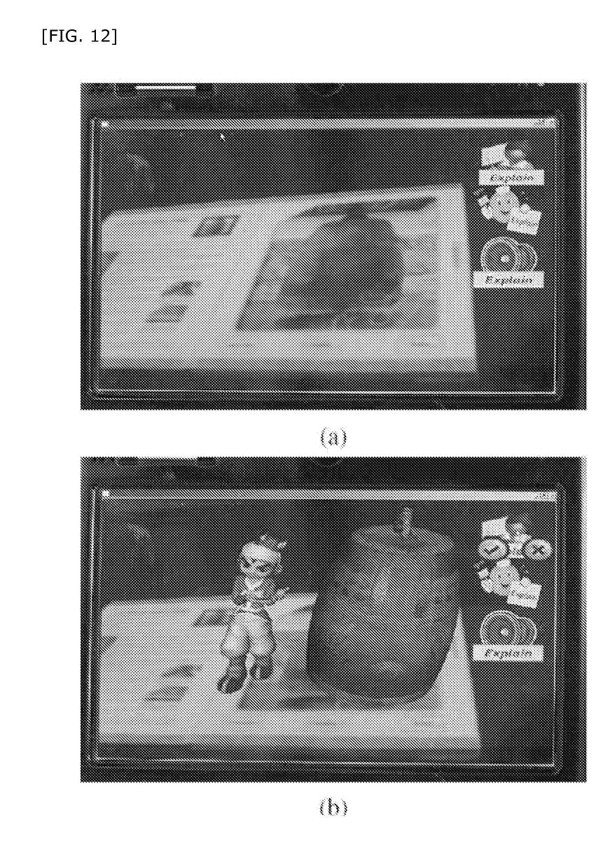

FIG. 12 is one example of an actually realized augmented reality system according to one embodiment of the present disclosure. In FIG. 12, content items are customized to a specific book. FIG. 12(a) shows a set of content items which have a high degree of similarity and are displayed on an upper right side of a screen, and FIG. 12(b) shows a content item that is displayed to overlap the book when selected by a user from among the set of content items.

When a user deletes a recommended content item, the system suggests another recommended content item to the user and updates user profile data according to such a user selection (that is, deletion), so that the system accumulates a recent user preference and provides a content item reflecting the recent user preference is provided to the user.

The aforementioned augmented reality system, and the mobile communication device and the server constituting the system may be realized by a process, and a detailed description of the process will be omitted herein since the process is described in detailed in descriptions of the mobile communication device, the server and the system.

As such, the present disclosure provides the user adaptive augmented reality system based on context recognition user profiling and content item filtering.

Although some exemplary embodiments have been described herein, it should be understood by those skilled in the art that these embodiments are given by way of illustration only, and that various modifications, variations, and alterations can be made without departing from the spirit and scope of the present invention. For example, the respective components of the embodiments may be embodied in different ways. Further, the scope of the present invention should be interpreted according to the following appended claims as covering all modifications or variations induced from the appended claims and equivalents thereof.

What is claimed is:

1. An augmented reality mobile communication device, comprising:
a context inference unit that receives sensory information and predicts a user context regarding a user of a mobile communication device based on the sensory information;
a transmission unit that transmits user context data to a server;
a receiving unit that receives a personalized content item from the server, the personalized content item being generated based on user profile data and user preference data corresponding to the user context data; and
an augmented reality content renderer that overlays the received personalized content item on an image photographed by a camera.

2. The augmented reality mobile communication device according to claim 1, wherein the sensory information comprises data sensed by a sensor of the mobile communication device or by a sensor distributed in an environment of the user.

3. The augmented reality mobile communication device according to claim 1, wherein the sensory information comprises user input data to the mobile communication device or data regarding an image input through the camera.

4. The augmented reality mobile communication device according to claim 1, wherein the context inference unit comprises:
a context collector that collects the sensory information and classifies the collected sensory information according to a preset standard; and
a context prediction unit that infers the user context based on the collected data.

5. The augmented reality mobile communication device according to claim 1, wherein the augmented reality content renderer comprises:
an object tracking unit that recognizes and traces an object of an image photographed by the camera; and
a content rendering unit that renders the personalized content item according to the object.

6. The augmented reality mobile communication device according to claim 5, wherein the content rendering unit renders the personalized content item in a data type and a presentation format based on the user profile data and the user preference data.

7. A method of realizing augmented reality in a user adaptive augmented reality mobile communication device, comprising:
predicting a user context regarding a user of the mobile communication device based on received sensory information;
transmitting user context data to a server;
receiving a personalized content item from the server, the personalized content item being generated based on user profile data and user preference data corresponding to the user context data; and
overlaying the received personalized content item on an image captured by a camera to provide augmented content.

8. An augmented reality server comprising:
a receiving unit that receives user context data from a mobile communication device of a user, the user context data being predicted based on sensory information;
a user profile manager that generates user profile data corresponding to the user context data;
a personalized content generator that predicts and filters a user preference according to the user context based on the user context data and the user profile data to generate a personalized content item; and
a transmission unit that transmits the personalized content item to the mobile communication device.

9. The augmented reality server according to claim 8, wherein the sensory information comprises data sensed by a sensor of the mobile communication device or by a sensor distributed in an environment of the user.

10. The augmented reality server according to claim 8, wherein the sensory information comprises user input data to the mobile communication device or data regarding an image input through the camera.

11. The augmented reality server according to claim 8, wherein the user input data comprises explicit input data of the user to the mobile communication device and logging data of the user to the mobile communication device.

12. The augmented reality server according to claim 11, wherein the user profile manager comprises:
an explicit profile generator that generates an explicit profile of the user based on the explicit input data;
an implicit profile generator that generates an implicit profile of the user based on the logging data; and
a user profile accumulator that accumulates and updates user profile data based on the explicit profile and the implicit profile.

13. The augmented reality server according to claim 8, wherein the personalized content generator comprises:
a content preference inference unit that predicts a content item preference of the user according to the user context based on the user context data and the user profile data; and
a content filtering unit that evaluates and filters content items in a content database according to a degree of similarity with respect to the content item preference.

14. The augmented reality server according to claim 13, wherein the content filtering unit evaluates and filters the content items based on a data type and a presentation format based on the user profile data and the user preference data.

15. A method of realizing augmented reality in a user adaptive augmented reality server, comprising:
receiving user context data from a mobile communication device of a user, the user context data being predicted based on sensory information;
generating user profile data according to the user context data;
generating a personalized content item by predicting and filtering a user preference according to the user context based on the user context data and the user profile data; and
transmitting the personalized content item to the mobile communication device.
